(19) United States
(12) Patent Application Publication
(10) Pub. No.: US 2004/0250694 A1
(43) Pub. Date: Dec. 16, 2004

(54) Method and apparatus for protecting baled hay from moisture

(76) Inventor: Clyde W. Lynde, Windsor, MO (US)

Correspondence Address: CHASE & YAKIMO, L.C., 4400 COLLEGE BOULEVARD, SUITE 130, OVERLAND PARK, KS, 66211

(21) Appl. No.: 10/330,628

(22) Filed: Dec. 27, 2002

(51) Int. Cl. B30B 9/30

(52) U.S. Cl. 100/8

(57) ABSTRACT

A system for applying one or more coatings of wax to a hay bale to provide protection from moisture. Additional coatings may be applied to hold the bale together without twine or plastic wrap. A fungicide or nutrient additive may be added to enhance the effectiveness of the wax protective coating and to provide additional nutrients to livestock eating the hay.

### BACKGROUND OF THE INVENTION

This invention relates to a method and apparatus for protecting baled hay and the like from moisture and, more particularly, to a method and apparatus for spraying the outer surface of a hay bale with a moisture resistant coating and a fungicide to protect the hay from deterioration when the bale is exposed to the environment, and to hold the bale together without string, twine or plastic sheeting.

Harvesting hay and the like is commonly accomplished by cutting the hay and permitting it to dry at least to a limited extent, form it into windrows and then collect the windrows to form separate rectangular bales tied by wire or twine. In more recent years, formation of the windrows into roll-type bales has become popular. The bales are formed into spiral rolls and bound together with twine or a plastic sheet wrapped around the circumference of the bale. It is not uncommon for bales of this type to weigh as much as 1200 to 1500 lbs. These bales are commonly stored in the field.

One problem with storing these bales wrapped with twine in the field is that they are exposed to moisture from rain and snow, and heat from the sun, which deteriorates the hay reducing its quality for animal consumption. Another problem with both the twine- and plastic-wrapped bales is the twine and plastic must be manually removed by the rancher or farmer and disposed of in order for the livestock to access the hay. The plastic and twine often litter the fields for years because they do not readily decompose or deteriorate. Protection against deterioration while stored in the field is highly desirable. As is reduction or elimination of the work necessary to untie the bales and the plastic waste.

Other devices have been proposed that consist of metal or plastic panels which cover the top of a bale. One such device is disclosed in U.S. Pat. No. 4,521,997 to Tiberend. These devices require manual placement on the bales and storage when they are manually removed. Additionally, these devices provide no protection from ground moisture.

### SUMMARY OF THE INVENTION

The present invention provides a method and apparatus to protect a hay bale from deterioration without the necessity of a separate plastic cover. A sprayer is used to spray the hay bale with a water-resistant coating to protect it from moisture and to reduce deterioration of the hay. The thickness of the coating may be adjusted to provide an adhesive layer to hold the bale together without binding twine, string or plastic wrap. A fungicide may also be mixed with the water-resistant coating to provide additional protection against molds and various other types of fungi. A wax and fungicide coating is applied to the surface of a round hay bale, which provides not only an enhanced control of hay decay, but simultaneously provides a moisture barrier to reduce deterioration. The apparatus includes an application means for applying the fungicide and wax to the surface of the bale. The spray means may be housed within a round baler or may be portable for treating bales that have already been dropped in a field or that have been hauled to a storage location such as along a fence, for example.

Other advantages of this invention will become apparent from the following description taken in connection with the accompanying drawings, wherein is set forth by way of illustration and example, a preferred embodiment of the present invention.

### BRIEF DESCRIPTION OF THE DRAWINGS

FIG. 1 is a sectional side view of a baler with the sprayer of the present invention.

FIG. 2 is an end elevational view of FIG. 1 with the interior components of the baler removed to show the sprayer.

FIG. 3 is a portable sprayer of the present invention.

### DETAILED DESCRIPTION

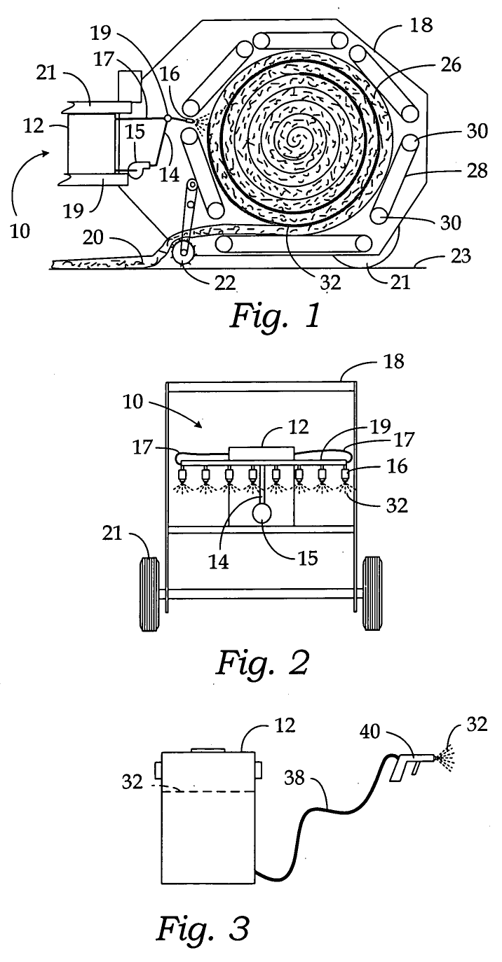

Referring to FIGS. 1 and 2, the bale sprayer of the present invention is generally indicated by reference numeral 10. Bale sprayer 10 includes a holding tank 12, spray lines 14, pump 15, spray heads 16, return line 17 and manifold 19. Bale sprayer 10 is mounted to a hay baler 18 such as a Vermeer round hay baler. Baler 18 is pulled behind a tractor (not shown) linked by a towing structure 21 on wheels 23 which engage ground surface 25. Baler 18 picks up hay such as grass, clover, alfalfa or other material 20, for example, which has been raked into a windrow. Pickup 22 directs the hay into the baler chamber 24. The hay 20 is rolled into a bale 26 by belts or bands 28 and rollers 30. As the bale 26 grows, hydraulic pressure is applied to the bands 28 and rollers 30 to tightly form bale 26.

During the last two to four turns, the surface of bale 26 is coated with a thin layer of a water-resistant coating 32 such as wax. In the preferred embodiment, a soybean-based paraffin wax or beeswax may be used to coat bale 26. Other waxes such as a rice-based wax may also be used. When added to the last two to four layers of bale 26, wax 32 holds the bale 26 together so that extra twine or plastic wrap is not necessary. Alternatively, wax 32 may be sprayed on the outside layer of bale 26 only to protect the bale 26 from moisture.

Twine used to tie a bale is threaded though one or more needles (not shown), which guide the twine back and forth around the bale as it is turned. One or more sprayer heads 16 may be attached to a needle to traverse the surface of the bale as it is turned to apply the wax coating.

Soy wax has several advantages over petroleum-based paraffins. First, soy wax includes proteins beneficial to livestock. Second, soy wax is water soluble and biodegradable. Over a period of two to three years, the outer layer of the wax will wash away through natural rainfall. However, the inner layers of bale 26 remain protected by the inner layers of wax 32.

Water-resistant coating 32 may also include a preservative or nutrients such as a fungicide and/or vitamins. Alternatively, a fungicide or nutrient may be separately applied throughout the layers of bale 26 for even distribution and wax 32 added only to the outer layers.

As shown in FIGS. 1 and 2, water-resistant coating 32 is applied to the outer circumferential surface of bale 26. However, additional spray heads 16 may be directed to the sides of bale 26 to provide further protection.

At room temperature wax 32 is solid. Thus, in order to spray wax 32, it needs to be heated beyond its melting point. The melting point of the wax may vary from about 110 to 195 degrees Fahrenheit. Tank 12 may be heated using an electric heater with power supplied by the tractor electrical circuit. A recirculating pump 15 may be used to keep the spray heads 16 and tubing 14 hot enough to ensure that wax 32 is melted. Electrical heat wrap tape (not shown) may also be used to preheat the system components. Wax 32 may also be heated by the hydraulic oil from the tractor (not shown). The hydraulic oil may be circulated through tubes in the wax tank 12 to warm the wax to a liquid state.

The amount of wax to apply to bale 26 may depend on the type of wax used, the high temperature expected for the area, and the average rainfall expected. In warmer dry climates, a wax with a higher melting point should be used to ensure that the wax does not melt under the hot sun and soak into the hay bale 26 to reduce protection for the outer layer. In a warm, wet environment, a soy wax may dissolve too quickly to provide long-term protection, thus a paraffin or beeswax may be more effective to protective hay bale 26.

Referring to FIG. 3, a sprayer may be attached to tank 12 to spray bales that are already formed and need protection from the elements. Tank 12 may be heated using the electrical system of a pickup truck or other vehicle (not shown) or the hydraulic heat generated by a tractor, for example. The heated wax may be delivered through spray line 38 to the spray head 40 by pressurizing tank 12 or by use of an electric or hydraulic pump or compressor, such as is used for spraying paints.

It is to be understood that while certain now preferred forms of this invention have been illustrated and described, it is not limited thereto except insofar as such limitations are included in the following claims.

Having thus described the invention, what is claimed as new and desired to be secured by Letters Patent is:

1. An apparatus for protecting hay formed into a bale comprising:
a sprayer tank for holding a wax,
means for heating said wax to a liquid state,
a spray head directed to the surface of the bale, and
means for delivering said liquid wax from said sprayer tank to said spray head under pressure,
whereby said liquid wax is sprayed on the surface of the bale to protect the bale from moisture.

2. The apparatus as claimed in claim 1 further comprising means to mount said sprayer tank to a vehicle.

3. The apparatus as claimed in claim 1 wherein said means for heating includes an electric heater.

4. The apparatus as claimed in claim 1 wherein said means for heating includes a hydraulic heater.

5. The apparatus as claimed in claim 1 wherein said means for delivering includes an air pump to pressurize said sprayer tank.

6. The apparatus as claimed in claim 1 wherein said means for delivering includes an electric pump.

7. The apparatus as claimed in claim 1 wherein said means for delivering includes a hydraulic pump.

8. The apparatus as claimed in claim 1 further comprising a fungicide mixed with said wax.

9. The apparatus as claimed in claim 1 further comprising a nutrient supplement mixed with said wax.

10. An apparatus for protecting hay formed into a bale by a baler, comprising:
a sprayer tank mounted to said baler for holding a wax,
a heater for heating said wax to a liquid state,
a spray head directed to the surface of the bale, and
means for delivering said liquid wax from said sprayer tank to said spray head under pressure,
whereby said liquid wax is sprayed on the surface of the bale.

11. The apparatus as claimed in claim 1 wherein said heater is an electric heater.

12. The apparatus as claimed in claim 1 wherein said heater is a hydraulic heater.

13. The apparatus as claimed in claim 1 wherein said means for delivering includes an air pump to pressurize said sprayer tank.

14. The apparatus as claimed in claim 1 wherein said means for delivering includes an electric pump.

15. The apparatus as claimed in claim 1 wherein said means for delivering includes a hydraulic pump.

16. The apparatus as claimed in claim 1 wherein said means for delivering includes a recirculating pump.

17. The apparatus as claimed in claim 1 further comprising a fungicide mixed with said wax.

18. The apparatus as claimed in claim 1 further comprising a nutrient supplement mixed with said wax.

19. An method for protecting hay formed into a bale by a baler, comprising steps of:
forming layers of hay into a bale in a baler,
heating a wax to a liquid state,
spraying said wax on the final layer of said hay, and
releasing the bale from the baler,
whereby said step of spraying said wax on the final layer of said hay provide a coating of wax on the bale outside surface to protect said bale from moisture.

20. The method as claimed in claim 19, wherein said wax includes a soy wax.

21. The method as claimed in claim 19, wherein said wax includes a beeswax.

22. The method as claimed in claim 19, wherein said wax includes a ricebran wax.

23. The method as claimed in claim 19, wherein said wax includes a fungicide.

24. The method as claimed in claim 19, further comprising the step of first spraying said wax on the penultimate layer of said hay, whereby said first spraying step and said spraying step hold said bale together.
